(19) United States
(12) Patent Application Publication
(10) Pub. No.: US 2006/0177657 A1
(43) Pub. Date: Aug. 10, 2006

(54) Sizing compositions for fibers utilizing low VOC silanes

(76) Inventor: Keith Weller, North Greenbush, NY (US)

Correspondence Address: DILWORTH & BARRESE, LLP, 333 EARLE OVINGTON BLVD., UNIONDALE, NY, 11553, US

(21) Appl. No.: 11/238,200

(22) Filed: Sep. 29, 2005

Related U.S. Application Data
(60) Provisional application No. 60/651,025, filed on Feb. 8, 2005.

(51) Int. Cl. C08L 91/06; C04B 41/50; D06M 15/643; C09D 183/04; C03C 25/24; C04B 41/49; C07F 7/18

(52) U.S. Cl. 428/364; 106/270; 106/287.1; 106/287.11; 106/287.12; 106/287.13; 106/287.14; 106/287.15; 106/287.16; 428/375

(57) ABSTRACT

A low VOC sizing composition includes a liquid carrier containing a silane which, upon hydrolysis, produces substantially no significant amount of volatile organic compound and/or the silicon-containing hydrolyzate of the silane. The sizing composition can optionally include one or more of film forming agents, anti-static agents, lubricants, surfactants, emulsifying agents, wetting agents, peroxide, starch, oil, plasticizer, wax, acids or bases.

### CROSS-REFERENCE TO RELATED APPLICATIONS

The present application claims priority to U.S. provisional application Ser. No. 60/651,025 filed Feb. 8, 2005, which is herein incorporated by reference.

### BACKGROUND OF THE INVENTION

The use of alkoxy-functional silanes in the sizing formulations used during the manufacture of glass fibers results in the release of alcohol upon the hydrolysis of the silane. This alcohol is typically methanol or ethanol, and can pose both air quality and worker safety issues. As the emission of volatile organic compounds becomes more tightly regulated, glass fiber manufacturers are many times forced to reduce production, install recovery or remediation equipment, or re-formulate sizes to meet new, stricter emission limits. Glass fiber producers need a more cost-effective way to reduce the emission of volatile organic compounds (VOCs) from their sizing bath formulations.

Sized fiber strands are used to reinforce both thermoplastic and thermosetting polymeric materials. It is common in the production of glass or carbon fibers to use sizing compositions to improve the processibility of the fibers, such as fiber bundle cohesion, bundling, spreadability, resistance to fuzz formation, fiber smoothness and softness, abrasion resistance, and windability. The sizing composition also improves the physical properties of composites that contain the fibers.

Size formulations commonly employ film formers, coupling or keying agents, processing aids (such as lubricants), anti-stats, surfactants, starches, and oils. Alkoxy-substituted silanes have been used in the glass fiber industry since the 1950's, and are still the material of choice for coupling agents in size formulations. Most of these materials are methoxy or ethoxy-substituted, and emit fairly large quantities of methanol or ethanol upon hydrolysis. Some of the more commonly used silanes include aminopropyltriethoxysilane (Silquest® A-1100), glycidoxypropyltrimethoxysilane (Silquest® A-187), ureidopropyltrimethoxysilane (Silquest® A-1524), beta-(3,4-epoxycyclohexyl)ethyltrimethoxysilane (Silquest® A-186), methacryloxypropyltrimethoxysilane (Silquest® A-174), and vinyltriethoxysilane (Silquest® A-151), available from General Electric Company. The typical use of these silanes requires their hydrolysis prior to inclusion in a size formulation. It is during this hydrolysis step that the majority of the alcohol is released. The alcohol is typically ventilated to the atmosphere, but is sometimes captured or burned using engineering controls, such as a regenerative thermal oxidizing (RTO) unit.

In some instances, conventional alkoxy-functional silanes can be prepared as stable, alcohol-free aqueous solutions, and these silane solutions can sometimes be utilized in sizes to reduce volatile emissions. An example would be the aqueous solution of aminopropyltrisilanol (Silquest® A-1106). However, in general, there are only a few examples where silanes can be prepared as stable, alcohol-free aqueous solutions. In addition, aqueous solutions of silanes typically result in increased costs to the end-user due to the extra processing steps required in their production, and the increased costs of shipment of the associated water.

### BRIEF DESCRIPTION OF THE INVENTION

A sizing composition is provided herein which comprises a liquid carrier containing silane which, upon hydrolysis, produces substantially no significant amount of volatile organic compound (VOC) and/or the silicon-containing hydrolyzate of the silane.

Sizes produced from such silanes advantageously offer reduced emissions of VOCs when compared to conventional alkoxy-functional silanes. Moreover, the silanes of the invention advantageously can be used in either aqueous or non-aqueous sizing formulations.

### DETAILED DESCRIPTION OF THE INVENTION

The sizing composition of the invention is produced by combining the low VOC silane/hydrolyzate of the invention with a liquid carrier. The carrier can include water, in which case the low VOC silane will hydrolyze a silicon-containing hydrolyzate without producing any significant amount of volatile organic compound by-product. Alternatively, the sizing composition can be non-aqueous, in which case the carrier can be an organic compound, the silane being applied therefrom to the fiber in an initially non-hydrolyzed or partially hydrolyzed condition with complete hydrolysis being achieved after application to the fiber.

Organic compounds suitable for use as carriers in the sizing compositions of this invention include, but are not limited to, linear and branched aliphatic and aromatic hydrocarbons, ethers, amorphous and microcrystalline waxes, polycaprolactones and aprotic solvents such as dimethylformamide and 1-methyl-2-pyrrolidinone. The sizing composition of the present invention can also optionally include such components as film forming agents, anti-static agent, lubricant, surfactants or emulsifying agents, wetting agents, peroxide, starch, oil, plasticizers, waxes, acids or bases. The silicon-containing hydrolyzate of the low VOC silane/hydrolyzate functions as a coupling agent and may be used alone or in combination with other coupling agents such as methacrylates, chromic chloride, titanium acetyl acetonate, and/or hydrolyzates of other silanes such as aminosilanes, epoxysilanes, and the like. The low VOC silane, upon partial or complete hydrolysis, produces no significant amount of lower alcohols or other VOCs. The expression “volatile organic compound” (VOC) as used herein shall be understood to apply to organic compounds which, in the substantially pure state, possess a boiling point up to about 185° C. at one atmosphere of pressure. Specific examples of such VOCs include, but are not limited to, methanol, ethanol, propanol, isopropanol, butanol, and 2-methoxyethanol.

The sizing composition herein is suitable for application to glass fibers or strands to provide such commonly manufactured glass products as mats, rovings, chopped strands, yarns, milled fibers, blown wool, etc. The sizing composition may also be used for application to carbon fibers, natural fibers (such as kenaf and hemp), basalt fibers, and other inorganic fibrous material. The sizing composition may be applied by any of a variety of methods known to those skilled in the art, including sprays, kiss rollers, pads, and the like.

In one embodiment of the invention, the low VOC silanes (inclusive of the partially or fully hydrolyzed silicon-containing products thereof) include cyclic diol-substituted silanes which on hydrolysis provide by-product diol of very low volatility. These silanes hydrolyze in a similar fashion to conventional, alkoxy-substituted silanes. Upon hydrolysis of a cyclic diol-substituted silane, the diol or diols is released, and a silicon-containing hydrolyzate similar in composition to that produced upon the hydrolysis of conventional alkoxy-substituted silane is formed. The common product of hydrolysis of conventional silane is a silanol-containing species, which may then react further, either with itself or with other species. The diol by-product resulting from the hydrolysis of cyclic diol-substituted silanes is not released in significant quantities into the environment due to its low vapor pressure. Therefore, since cyclic diol-substituted silanes hydrolyze to produce silanol-containing species, they react in a similar fashion as conventional silanes, but do not release volatile organic compounds, such as alcohols.

In accordance with another embodiment of the invention, silane useful in the sizing composition of the present invention is represented by the general formula:
[Y [-G(-SiXᵤZ^{b}ᵥZ^{c}_{w})ₛ]ᵣ]ₙ (Formula 1)

wherein each occurrence of G is independently chosen from a set of groups comprising a polyvalent group derived by substitution of one or more hydrogen atoms of an alkyl, alkenyl, aryl or aralkyl group, or a molecular component which can be obtained by removal of one or more hydrogen atoms of a heterocarbon, with G containing from about 1 to about 30 carbon atoms; each occurrence of X is independently selected from the group consisting of —Cl, —Br, R¹O—, R¹C(═O)O—, R¹R²C═NO—, R¹R²NO— or R¹R²N—, —R¹, —(OSiR¹R²)ₜ(OSi R¹R²R³), and —O(R¹⁰CR¹¹)_{f}OH, wherein each occurrence of R¹, R², R³, R¹⁰, and R¹¹ is independently R; each occurrence of Z^{b} is independently (—O—)_{0.5}, and [—O(R¹⁰CR¹¹)_{f}O—]_{0.5}, wherein each occurrence of R¹⁰ and R¹¹ is independently R; each occurrence of Z^{c} is independently given by —O(R¹⁰CR¹¹)_{f}O— wherein each occurrence of R and R¹⁻¹¹ is independently R; each occurrence of R is chosen independently from the set of groups comprising hydrogen; straight, cyclic or branched alkyl groups and may contain unsaturated, alkenyl groups, aryl groups, and aralkyl groups; or molecular components obtained by removal of one or more hydrogen atoms of a heterocarbon; each occurrence of R containing 1 to about 20 carbon atoms; each occurrence of the subscript f is an integer from 1 to about 15, each occurrence of n is an integer from 1 to about 100, with the proviso that when n is greater than 1, v is a greater than 0 and all the valences for Z^{b} have a silicon atom bonded to them, each occurrence of the subscript u is an integer from 0 to about 3, each occurrence of the subscript v is an integer from 0 to about 3, each occurrence of the subscript w is an integer from 0 to about 1, with the proviso that u+v+2w=3, each occurrence of the subscript r is an integer from 1 to about 6, each occurrence of the subscript t is an integer from 0 to about 50, and each occurrence of the subscript s is an integer from 1 to about 6; and each occurrence of Y is an organofunctional group of valence r; and at least one cyclic and bridging dialkoxy organofunctional silane comprising the cyclic and bridging dialkoxy organofunctional silane composition containing at least one occurrence of Z^{b} or Z^{c}.

More particularly, group Y herein includes univalent organofunctional groups (r=1), divalent organofunctional groups (r=2), trivalent organofunctional groups (r=3), tetravalent organofunctional groups (r=4), as well as organofunctional groups of higher valency, herein referred to as polyvalent organofunctional groups. The term polyvalent organofunctional group herein shall be understood to include univalent, divalent, trivalent, and tetravalent organofunctional groups.

Y can be a univalent group such as vinyl groups CH₂═CH—, CHR═CH—, or CR₂═CH—, wherein R is as set forth above. Moreover, the silane can include univalent organofunctional groups such as mercapto and acyloxy groups such as acryloxy, methacryloxy and acetoxy, univalent epoxys such as glycidoxy, —O—CH₂—C₂H₃O; epoxycyclohexylethyl, —CH₂—CH₂—C₆H₉O; epoxycyclohexyl, —C₆H₉O; epoxy, —CR⁶(—O—)CR⁴R⁵, univalent organofunctional groups such as hydroxy, carbamate, —NR⁴C(═O)OR⁵; urethane, —OC(═O)NR⁴R⁵; thiocarbamate, —NR⁴C(═O)SR⁵; thiourethane, —SC(═O)NR⁴R⁵; thionocarbamate, —NR⁴C(═S)OR⁵; thionourethane, —OC(═S)NR⁴R⁵; dithiocarbamate, —NR⁴C(═S)SR⁵; and dithiourethane, —SC(═S)NR⁴R⁵, univalent organofunctional groups such as maleimide; maleate and substituted maleate; fumurate and substituted fumurate; nitrile, CN; citraconimide, univalent organofunctional groups such as cyanate, —OCN; isocyanate, —N═C═O; thiocyanate, —SCN; isothiocyanate, —N═C═S; and ether, —OR⁴, univalent organofunctional groups such as fluoro, —F; chloro, —Cl; bromo, —Br; iodo, —I; and thioether, —SR⁴, univalent organofunctional groups such as disulfide, —S—SR⁴; trisulfide, —S—S—SR⁴; tetrasulfide, —S—S—S—SR⁴; pentasulfide, —S—S—S—S—SR⁴; hexasulfide, —S—S—S—S—S—SR⁴; and polysulfide, —SₓR⁴, univalent organofunctional groups such as xanthate, —SC(═S)OR⁴; trithiocarbonate, —SC(═S)SR⁴; dithiocarbonate, —SC(═O)SR⁴; ureido, —NR⁴C(═O)NR⁵R⁶; thionoureido (also better known as thioureido), —NR⁴C(═S)NR⁵R⁶; amide, R⁴C(═O)NR⁵— and —C(═O)NR⁴R⁵—; thionoamide (also better known as thioamide), R⁴C(═S)NR⁴—; univalent melamino; and, univalent cyanurato, univalent organofunctional groups such as primary amino, —NH₂; secondary amino, —NHR⁴; and tertiary amino, —NR⁴R⁵.univalent diamino, —NR⁴-L¹-NR⁵R⁶; univalent triamino, —NR⁴-L¹(-NR⁵R⁶)₂ and —NR⁴-L¹-NR⁵-L²-NR⁶R⁷; and univalent tetraamino, —NR⁴-L¹(-NR⁵R⁶)₃, —NR⁴-L¹-NR⁵-L²-NR⁶-L³-NR⁷R⁸, and —NR⁴-L¹-N(-L²NR⁵R⁶)₂; wherein each occurrence of L¹, L², and L³ is selected independently from the set of structures given above for G; each occurrence of R⁴, R⁵, R⁶, R⁷ and R⁸ is independently given by one of the structures listed above for R; and each occurrence of the subscript, x, is independently given by x is 1 to 10.

In another embodiment, the silane can include divalent organofunctional groups such as epoxy, -(−)C(—O—)CR⁴R⁵ and —CR⁵(—O—)CR⁴—, divalent organofunctional groups such as carbamate, -(−)NC(═O)OR⁵; urethane, —OC(═O)NR⁴—; thiocarbamate, -(−)NC(═O)SR⁵; thiourethane, —SC(═O)NR⁴—; thionocarbamate, -(−)NC(═S)OR⁵; thionourethane, —OC(═S)NR⁴—; dithiocarbamate, -(−)NC(═S)SR⁵; dithiourethane, —SC(═S)NR⁴—; and ether, —O—, divalent organofunctional groups such as maleate and substituted maleate; fumarate and substituted fumarate, thioether, —S—; disulfide, —S—S—; trisulfide, —S—S—S—; tetrasulfide, —S—S—S—S—; pentasulfide, —S—S—S—S—S—; hexasulfide, —S—S—S—S—S—S—; and polysulfide, —Sₓ—, divalent organofunctional groups such as xanthate, —SC(═S)O—; trithiocarbonate, —SC(═S)S—; dithiocarbonate, —SC(═O)S—; ureido, -(−)NC(═)NR⁴R⁵ and —NR⁴C(═O)NR⁵—; thionoureido, also better known as thioureido, -(−)NC(═S)NR⁴R⁵ and —NR⁴C(═S)NR⁵—; amide, R⁴C(═O)N(−)— and —C(═O)NR⁴—; thionoamide, also better known as thioamide, R⁴C(═S)N(−)-; divalent melamino; divalent cyanurato, divalent organofunctional groups such as secondary amino, —NH—; tertiary amino, —NR⁴—; divalent diamino, -(−)N-L¹-NR⁴R⁵ and —NR⁴-L¹-NR⁵—; divalent triamino, (−)NR⁴)₂-L¹-NR⁵-R⁶, -(−)N-L¹-NR⁵-L²-NR⁶R⁷, —NR⁴-L¹-N(−)-L²-NR⁵R⁶, and —NR⁴-L¹-NR⁵-L²-NR⁶—; and divalent tetraamino, -(−)N-L¹-(NR⁵R⁶)₃, (—NR⁴)₂-L¹-(NR⁵R⁶)₂, -(−)N-L¹-NR⁴-L²-NR⁵-L³-NR⁶R⁷, —NR⁴-L¹-N(−)-L²-NR⁵-L³-NR⁶R⁷, —NR⁴-L¹-NR⁵-L²-NR⁵-L²-N(−)-L³-NR⁶R⁷, —NR⁴-L¹-NR⁵-L²-NR⁶-L³-NR⁷, -(−)N-L¹-N(L²NR⁵R⁶)₂, and (—NR⁴L¹-)₂N-L²NR⁵R⁶; wherein each occurrence of L¹, L², and L³ is selected independently from the set of structures given above for G; each occurrence of R⁴, R⁵, R⁶, and R⁷ is independently given by one of the structures listed above for R; and each occurrence of the subscript, x, is independently given by x is 1 to 10.

In another embodiment, the silane can include trivalent organofunctional groups such as epoxy, -(−)C(—O—)CR⁴—, trivalent organofunctional groups such as carbamate, -(−)NC(═O)O—; thiocarbamate, -(−)NC(═O)S—; thionocarbamate, -(−)NC(═S)O—; and dithiocarbamate, -(−)NC(═S)S—, ureido, -(−)NC(═O)NR⁴—; thionoureido, also better known as thioureido, -(−)NC(═S)NR⁴—; amide, —C(═O)N(−)-; thionoamide, also better known as thioamide, —C(═S)N(−)-; trivalent melamino; and trivalent cyanurato, trivalent organofunctional groups such as tertiary amino, —N(−)-; trivalent diamino, -(−)N-L¹-NR⁴—; trivalent triamino, (—NR⁴)₃-L¹, (—NR⁴)₂-L¹-NR⁵—, -(−)N-L¹-N(−)-L²-NR³R⁴, —NR⁴-L¹-N(−)-L²-NR⁵—, and -(−)N-L¹-NR⁴-L²-NR⁵—; and trivalent tetraarnino, -(−)N-L¹-N(−)-L²-NR⁵-L³NR³R⁴, —NR⁴-L¹-N(−)-L²-N(−)-L³-NR³R⁴, -(−)N-L¹-NR⁵-L²-N(−)-L³-NR³R⁴, —NR⁴-L¹-N(−)-L²-NR³-L³-NR⁴—, -(−)N-L¹-N(-L²NR³R⁴)(-L²NR⁵—), and (—NR⁴L¹-)₃N; wherein each occurrence of L¹, L², and L³ is selected independently from the set of structures given above for G; and each occurrence of R⁴, R⁵, and R⁶ is independently given by one of the structures listed above for R.

In another embodiment, the silane can include tetravalent organofunctional group such as epoxy, -(−)C(—O—)C(−)-; tetravalent organofunctional groups such as ureido, -(−)NC(═O)N(−)-; thionoureido (also better known as thioureido), -(−)NC(═S)N(−)-; and tetravalent melamine, tetravalent organofunctional groups tetravalent diamino, -(−)N-L¹-N(−)-; tetravalent triamino, (—NR⁴)₄-L¹, (—NR⁴)₂-L¹-N(−)-, -(−)N-L¹-N(−)-L²-NR³—, and -(−)N-L¹-NR⁴-L²(−)-; and tetravalent tetraamino, -(−)N-L¹-N(−)-L²-N(−)-L³-NR⁴R³, —NR⁴-L¹-N(−)-L²-N(−)-L³-NR³—, -(−)N-L¹-NR⁴-L²-NR³-L³-N(−)-, and -(−)N-L¹-N(-L²NR³—)₂; wherein each occurrence of L¹, L², and L³ is selected independently from the set of structures given above for G; and each occurrence of R⁴ and R⁵ is independently given by one of the structures listed above for R.

In another embodiment, the silane can include polyvalent organofunctional groups such as, but not limited to, polyvalent hydrocarbon groups; pentavalent melamino, (—NR³)(—N—)₂C₃N₃; hexavalent melamino, (—N—)₃C₃N₃; pentavalent triamino, -(−)N-L¹-N(−)-L²-N(−)-; pentavalent tetraamino, -(−)N-L¹-N(−)-L²-N(−)-L³-NR³—, -(−)N-L¹-NR³-L²-N(−)-L³-N(−)-, and [-(−)N-L¹]₂N-L²NR³—; and hexavalent tetraamino, -(−)N-L¹-N(−)-L²-N(−)-L³-N(−)- and [-(−)N-L¹-]₃N; wherein each occurrence of L¹, L², and L³ is selected independently from the set of structures given above for G; and each occurrence of R⁴ is independently given by one of the structures listed above for R.

As used herein, diol, hydrocarbon diol, and difunctional alcohol refer to any structure given by Formula 2:
HO(R¹⁰CR¹¹)_{f}OH (Formula 2)
wherein f, R¹⁰, and R¹¹ are as defined above. These structures represent hydrocarbons or heterocarbons in which two hydrogen atoms are replaced with OH in accordance with the structures drawn in Formula 2. As used herein, dialkoxy and difunctional alkoxy refer to any hydrocarbon diol, as defined herein, in which the hydrogen atoms of the two OH groups have been removed to a give divalent radical, and whose structure is given by Formula 3:
—O(R¹⁰CR¹¹)_{f}O— (Formula 3)
wherein f, R¹⁰, and R¹¹ are as defined above. As used herein, cyclic dialkoxy refers to a silane or group in which cyclization is about silicon, by two oxygen atoms each attached to a common divalent hydrocarbon or heterocarbon group, such as is commonly found in diols. Cyclic dialkoxy groups herein are represented by Z^{c}. As used herein, bridging dialkoxy refers to a silane or group in which two different silicon atoms are each bound to one oxygen atom, which is in turn bound to a common divalent hydrocarbon or heterocarbon group as defined herein, such as is commonly found in diols. Bridging dialkoxy groups herein are represented by Z^{b}. As used herein, cyclic and bridging refers to a silane or group encompassing cyclic only, without bridging; bridging only, without cyclic, and any combination of both cyclic and bridging. Thus, a cyclic and bridging silane could mean, for example, a silane with a silicon atom bound to a cyclic dialkoxy group, a silane with a silicon atom not bound to a cyclic dialkoxy group and bound to bridging dialkoxy group(s) only, a silane with silicon bound to both one end of a bridging dialkoxy group and both ends of a cyclic dialkoxy group, a silane with a silicon atom not bound at all to a dialkoxy group (as long as at least one other silicon atom in the same molecule is bound to at least one cyclic or bridging dialkoxy group), etc. As used herein, hydrocarbon based diols refer to diols, which contain two OH groups on a hydrocarbon or heterocarbon structure. The term, “hydrocarbon based diol”, refers to the fact that the backbone between the two oxygen atoms consists entirely of carbon atoms, carbon-carbon bonds between the carbon atoms, and two carbon-oxygen bonds encompassing the alkoxy ends. The heterocarbons in the structure occur pendent to the carbon backbone.

The structures given by Formula 2 will herein be referred to as the appropriate diol, in a few specific cases, glycol is the more commonly used term, prefixed by the particular hydrocarbon or heterocarbon group associated with the two OH groups. Examples include neopentylglycol, 1,3-butanediol, and 2-methyl-2,4-pentanediol. The groups whose structures are given by Formula 3 will herein be referred to as the appropriate dialkoxy, prefixed by the particular hydrocarbon or heterocarbon group associated with the two OH groups. Thus, for example, the diols, neopentylglycol, 1,3-butanediol, and 2-methyl-2,4a-pentanediol correspond herein to the dialkoxy groups, neopentylglycoxy, 1,3-butanedialkoxy, and 2-methyl-2,4-pentanedialkoxy, respectively.

The cyclic and bridging dialkoxy organofunctional silanes used herein, in which the silane is derived from a diol, commonly referred to as a glycol, are correspondingly glycoxysilanes. Also, the cyclic and bridging organofunctional dialkoxy silanes used herein, in which the silane is derived from a diol, commonly referred to as a diol, are correspondingly named dialkoxysilanes.

As used herein, the notations, (—O—)_{0.5} and [—O(R¹⁰CR¹¹)_{f}O—]_{0.5}, refer to one half of a siloxane group, Si—O—Si, and one half of a bridging dialkoxy group, respectively. These notations are used in conjunction with a silicon atom and they are taken herein to mean one half of an oxygen atom, namely, the half bound to the particular silicon atom, or to one half of a dialkoxy group, namely, the half bound to the particular silicon atom, respectively. It is understood that the other half of the oxygen atom or dialkoxy group and its bond to silicon occurs somewhere else in the overall molecular structure being described. Thus, the (—O—)_{0.5} siloxane groups and the [—O(R¹⁰CR¹¹)_{f}O—]_{0.5} dialkoxy groups mediate the chemical bonds that hold two separate silicon atoms together, whether these two silicon atoms occur intermolecularly or intramolecularly. In the case of [—O(R¹⁰CR¹¹)_{f}O—]_{0.5}, if the hydrocarbon group, (R¹⁰CR¹¹)_{f}, is unsymmetrical, either end of [—O(R¹⁰CR¹¹)_{f}]_{0.5} may be bound to either of the two silicon atoms required to complete the structures given in Formula 1.

As used herein, alkyl includes straight, branched and cyclic alkyl groups; alkenyl includes any straight, branched, or cyclic alkenyl group containing one or more carbon-carbon double bonds, where the point of substitution can be either at a carbon-carbon double bond or elsewhere in the group. Also, alkynyl includes any straight, branched, or cyclic alkynyl group containing one or more carbon-carbon triple bonds and optionally also one or more carbon-carbon double bonds as well, where the point of substitution can be either at a carbon-carbon triple bond, a carbon-carbon double bond, or elsewhere in the group. Specific examples of alkyls include methyl, ethyl, propyl, isobutyl. Specific examples of alkenyls include vinyl, propenyl, allyl, methallyl, ethylidenyl norbornane, ethylidene norbornyl, ethylidenyl norbornene and ethylidene norbornenyl. Specific examples of alkynyls include acetylenyl, propargyl and methylacetylenyl.

As used herein, aryl includes any aromatic hydrocarbon from which one hydrogen atom has been removed; aralkyl includes any of the aforementioned alkyl groups in which one or more hydrogen atoms have been substituted by the same number of like and/or different aryl (as defined herein) substituents; and arenyl includes any of the aforementioned aryl groups in which one or more hydrogen atoms have been substituted by the same number of like and/or different alkyl (as defined herein) substituents. Specific examples of aryls include phenyl and naphthalenyl. Specific examples of aralkyls include benzyl and phenethyl. Specific examples of arenyls include tolyl and xylyl.

As used herein, cyclic alkyl, cyclic alkenyl and cyclic alkynyl also include bicyclic, tricyclic, and higher cyclic structures, as well as the aforementioned cyclic structures further substituted with alkyl, alkenyl and/or alkynyl groups. Representive examples include norbornyl, norbornenyl, ethylnorbornyl, ethylnorbornenyl, ethylcyclohexyl, ethylcyclohexenyl, cyclohexylcyclohexyl, and cyclododecatrienyl.

As used herein, the term, heterocarbon, refers to any hydrocarbon structure in which the carbon-carbon bonding backbone is interrupted by bonding to atoms of nitrogen and/or oxygen; or in which the carbon-carbon bonding backbone is interrupted by bonding to groups of atoms containing nitrogen and/or oxygen, such as cyanurate (C₃N₃O₃). Thus, heterocarbons include, but are not limited to branched, straight-chain, cyclic and/or polycyclic aliphatic hydrocarbons, optionally containing ether functionality via oxygen atoms each of which is bound to two separate carbon atoms, tertiary amine functionality via nitrogen atoms each of which is bound to three separate carbon atoms, melamino groups and/or cyanurate groups; aromatic hydrocarbons; and arenes derived by substitution of the aforementioned aromatics with branched or straight chain alkyl, alkenyl, alkynyl, aryl and/or aralkyl groups.

Representative examples of G include —(CH₂)ₘ— wherein m is 1 to 12; diethylene cyclohexane; 1,2,4-triethylene cyclohexane; diethylene benzene; phenylene; —(CH₂)ₚ— wherein p is 1 to 20, which represent the terminal straight-chain alkyls further substituted terminally at the other end, such as —CH₂—, —CH₂CH₂—, —CH₂CH₂CH₂—, and —CH₂CH₂CH₂CH₂CH₂CH₂CH₂CH₂—, and their beta-substituted analogs, such as —CH₂(CH₂)_{q}CH(CH₃)—, where q is zero to 17; —CH₂CH₂C(CH₃)₂CH₂—; the structure derivable from methallyl chloride, —CH₂CH(CH₃)CH₂—; any of the structures derivable from divinylbenzene, such as —CH₂CH₂(C₆H₄)CH₂CH₂— and —CH₂CH₂(C₆H₄)CH(CH₃)—, where the notation C₆H₄ denotes a disubstituted benzene ring; any of the structures derivable from dipropenylbenzene, such as —CH₂CH(CH₃)(C₆H₄)CH(CH₃)CH₂—, where the notation C₆H₄ denotes a disubstituted benzene ring; any of the structures derivable from butadiene, such as —CH₂CH₂CH₂CH₂—, —CH₂CH₂CH(CH₃)—, and —CH₂CH(CH₂CH₃)—; any of the structures derivable from piperylene, such as CH₂CH₂CH₂CH(CH₃)—, —CH₂CH₂CH(CH₂CH₃)—, and —CH₂CH(CH₂CH₂CH₃)—; any of the structures derivable from isoprene, such as —CH₂CH(CH₃)CH₂CH₂—, —CH₂CH(CH₃)CH(CH₃)—, —CH₂C(CH₃)(CH₂CH₃)—, —CH₂CH₂CH(CH₃)CH₂—, —CH₂CH₂C(CH₃)₂— and —CH₂CH[CH(CH₃)₂]—; any of the isomers of —CH₂CH₂-norbonyl-, —CH₂CH₂-cyclohexyl-; any of the diradicals obtainable from norbornane, cyclohexane, cyclopentane, tetrahydrodicyclopentadiene, or cyclododecene by loss of two hydrogen atoms; the structures derivable from limonene, —CH₂CH(4-methyl-1-C₆H₉—)CH₃, where the notation C₆H₉ denotes isomers of the trisubstituted cyclohexane ring lacking substitution in the 2 position; any of the monovinyl-containing structures derivable from trivinylcyclohexane, such as —CH₂CH₂(vinylC₆H₉)CH₂CH₂— and —CH₂CH₂(vinylC₆H₉)CH(CH₃)—, where the notation C₆H₉ denotes any isomer of the trisubstituted cyclohexane ring; any of the monounsaturated structures derivable from myrcene containing a trisubstituted C═C, such as —CH₂CH[CH₂CH₂CH═C(CH₃)₂]CH₂CH₂—, —CH₂CH[CH₂CH₂CH═C(CH₃)₂]CH(CH₃)—, —CH₂C[CH₂CH₂CH═C(CH₃)₂](CH₂CH₃)—, —CH₂CH₂CH[CH₂CH₂CH═C(CH₃)₂]CH₂—, —CH₂CH₂(C—)(CH₃)[CH₂CH₂CH═C(CH₃)₂], and —CH₂CH[CH(CH₃)[CH₂CH₂CH═C(CH₃)₂]]—; and any of the monounsaturated structures derivable from myrcene lacking a trisubstituted C═C, such as —CH₂CH(CH═CH₂)CH₂CH₂CH₂C(CH₃)₂—, —CH₂CH(CH═CH₂)CH₂CH₂CH[CH(CH₃)₂]—, —CH₂C(═CH—CH₃)CH₂CH₂CH₂C(CH₃)₂—, —CH₂C(═CH—CH₃)CH₂CH₂CH[CH(CH₃)₂]—, —CH₂CH₂C(═CH₂)CH₂CH₂CH₂C(CH₃)₂—, —CH₂CH₂C(═CH₂)CH₂CH₂CH[CH(C₃]—, —CH₂CH═C(CH₃)₂CH₂CH₂CH₂C(CH₃)₂—, and CH₂CH═C(CH₃)₂CH₂CH₂CH[CH(CH₃)₂].

Representative examples of R groups are H, branched and straight-chain alkyls of 1 to 20 carbon atoms such as methyl, ethyl, propyl, isopropyl, butyl, octenyl, cyclohexyl, phenyl, benzyl, tolyl, allyl, methoxyethyl, ethoxyethyl dimethylaminoethyl, cyanoethyl, and the like. In another embodiment, representative R¹⁰ and R¹¹ groups are hydrogen, methyl, and ethyl, of which hydrogen and methyl are most preferred. In yet another embodiment, representative R¹ and R² groups can be hydrogen, methyl, ethyl, propyl. In still another embodiment, representative examples of R³, R⁴, R⁵, R⁶, R⁷, and R⁸ groups can be H₂, C₁ to C₄ straight chain or branched alkyls such as methyl, ethyl, propyl, isopropyl, butyl, isobutyl, pentyl, hexyl, heptyl, octyl, and aryl such as phenyl, benzyl, etc.

Specific examples of X are methoxy, ethoxy, propoxy, isopropoxy, isobutoxy, acetoxy, methoxyethoxy, and oximato, as well as the monovalent alkoxy groups derived from diols, known as “dangling diols”, specifically, groups containing an alcohol and an alkoxy, such as —O—CH₂CH—OH), such as ethylene glycol, propylene glycol, neopentyl glycol, 1,3-propanediol, 2-methyl-1,3-propanediol, 1,3-butanediol, 2-methyl-2,4-pentanediol, 1,4-butanediol, cyclohexane dimethanol, and pinacol. In another embodiment, specific examples of X are methoxy, acetoxy and ethoxy, as well as the monovalent alkoxy groups derived from the diols, ethylene glycol, propylene glycol, neopentyl glycol, 1,3-propanediol, 2-methyl-1,3-propanediol, 1,3-butanediol, and 2-methyl-2,4-pentanediol.

Specific examples of Z^{b} and Z^{c} can be the divalent alkoxy groups derived from diols, such as ethylene glycol, propylene glycol, neopentyl glycol, 1,3-propanediol, 2-methyl-1,3-propanediol, 1,3-butanediol, 2-methyl-2,4-pentanediol, 1,4-butanediol, cyclohexane dimethanol, and pinacol. In another embodiment, specific examples of Z^{b} and Z^{c} are the divalent alkoxy groups derived from the diols such as ethylene glycol, propylene glycol, neopentyl glycol, 1,3-propanediol, 2-methyl-1,3-propanediol, 1,3-butanediol, and 2-methyl-2,4-pentanediol are preferred. The divalent alkoxy groups derived from the diols, 1,3-propanediol, 2-methyl-1,3-propanediol, 1,3-butanediol, and 2-methyl-2,4-pentanediol. The bridging (Z^{b}) content of the cyclic and bridging organofunctional silane compositions herein must be kept sufficiently low to prevent excessive average molecular weights and crosslinking, which would lead to gelation.

Additional embodiments are wherein v and w in Formulas 1 can be such that the ratio of w/v is between 1 and 9; X is RO—, RC(═O)O—; Z^{b} and Z^{c} can be derived from the diols, 1,3-propanediol, 2-methyl-1,3-propanediol, 1,3-butanediol, 2-methyl-2,4-pentanediol; R is alkyls of C₁ to C₄ and H; and G is a divalent straight chain alkyl of 2 to 18 carbon atoms. Other embodiments include those wherein w/v is between 2 and 8; X is ethoxy or one or more of the dangling diols derived from the diols, 1,3-propanediol, 2-methyl-1,3-propanediol, 1,3-butanediol, and 2-methyl-2,4-pentanediol; and G is a C₂-C₁₂ straight-chain alkyl derivative. Another embodiment are wherein v in Formula 1 is 0; X is RO—, RC(═O)O—; R is alkyls of C₁ to C₄ and H; and G is a divalent straight chain alkyl of 2 to 18 carbon atoms.

Representative examples of the cyclic and bridging dialkoxy organofunctional silanes described in the present invention include 2-(2-methyl-2,4 pentanedialkoxyethoxysilyl)-1-propyl amine; 2-(2-methyl-2,4-pentanedialkoxyisopropoxysilyl)-1-propyl mercaptan; 2-(2-methyl-2,4-pentanedialkoxymethylsilyl)-1-propyl chloride; 2-(2-methyl-2,4-pentanedialkoxyphenylsilyl)-1-propyl bromide; 3-(1,3-butanedialkoxyethoxysilyl)-1-propyl iodide; 3-(1,3-butanedialkoxyisopropoxysilyl)-1-propyl chloride; N-[3-(1,3-propanedialkoxyethoxysilyl)-1-propyl]phenylamine; N-[3-(1,3-propanedialkoxyisopropoxysilyl)-1-propyl]methylamine; 3-(1,2-propanedialkoxyethoxysilyl)-1-propyl glycidyl ether and 3-(1,2-propanedialkoxyisopropoxysilyl)-1-propyl methacrylate, both derivable from propylene glycol; 3-(1,2-ethanedialkoxyethoxysilyl)-1-propyl acrylate and 3-(1,2-ethanedialkoxyisopropoxysilyl)-1-propyl acetate, both derivable from ethylene glycol; 3-(neopentyl glycoxyethoxysilyl)-1-propyl amine and 3-(neopentyl glycoxyisopropoxysilyl)-1-propyl glycidyl ether, both derivable from neopentyl glycol; 3-(2,3-dimethyl-2,3-butanedialkoxyethoxysilyl)-1-propyl acrylate and 3-(2,3-dimethyl-2,3-butanedialkoxyisopropoxysilyl)-1-propyl methacrylate, both derivable from pinacol; 3-(2,2-diethyl-1,3-propanedialkoxyethoxysilyl)-1-propyl mercaptan; S-[3-(2,2-diethyl-1, propanedialkoxyisopropoxysilyl)-1-propyl]ethylthioether; bis[3-(2-methyl-1,3-propanedialkoxyethoxysilyl)-1-propyl]disulfide; bis[3-(2-methyl-1,3-propanedialkoxyisopropoxysilyl)-1-propyl]trisulfide; bis[3-(1,3-butanedialkoxymethylsilyl)-1-propyl]tetrasulfide; bis[3-(1,3-propanedialkoxymethylsilyl)-1-propyl]thioether; 3-(1,3-propanedialkoxyphenylsilyl)-1-propyl glycidyl thioether; tris-N,N′,N″-[3-(1,2-propanedialkoxymethylsilyl)-1-propyl]melamine and tris-N,N′N″-[3-(1,2-propanedialkoxyphenylsilyl)-1-propyl]melamine, both derivable from propylene glycol; 3-(1,2-ethanedialkoxymethylsilyl)-1-propyl chloride and 3-(1,2-ethanedialkoxyphenylsilyl)-1-propyl bromide, both derivable from ethylene glycol; 3-(neopentyl glycoxymethylsilyl)-1-propyl acetate and 3-(neopentyl glycoxyphenylsilyl)-1-propyl octanoate, both derivable from neopentyl glycol; 3-(2,3-dimethyl-2,3-butanedialkoxymethylsilyl)-1-propyl amine and 3-(2,3-dimethyl-2,3-butanedialkoxyphenylsilyl)-1-propyl amine, both derivable from pinacol; 3-(2,2-diethyl-1,3-propanedialkoxymethylsilyl)-1-propyl acrylate; 3-(2,2-diethyl-1,3-propanedialkoxyphenylsilyl)-1-propyl methacrylate; 3-(2-methyl-1,3-propanedialkoxyethylsilyl)-1-propyl glycidyl ether; 3-(2-methyl-1,3-propanedialkoxyphenylsilyl)-1-propyl acetate; 2-(2-methyl-2,4-pentanedialkoxyethoxysilyl)-1-ethyl acrylate; 2-(2-methyl-2,4-pentanedialkoxymethoxysilyl)-1-ethyl bromide; 2-(2-methyl-2,4-pentanedialkoxy methylsilyl)-1-ethyl benzenesulfonate; 2-methyl-2,4-pentanedialkoxyethoxysilylmethyl methacrylate; 2-methyl-2,4-pentanedialkoxyisopropoxysilylmethyl bromide; neopentylglycoxypropoxysilylmethyl amine; propyleneglycoxymethylsilylmethyl mercaptan; neopentylglycoxyethylsilylmethyl glycidyl ether; 2-(neopentylglycoxyisopropoxysilyl)-1-ethyl butyrate; 2-(neopentylglycoxy methylsilyl)-1-ethyl propionate; 2-(1,3-butanedialkoxymethylsilyl)-1-ethyl acrylate; 3-(1,3-butanedialkoxyisopropoxysilyl)-4-butyl methacrylate; 3-(1,3-butanedialkoxyethylsilyl)-1-propyl mercaptan; 3-(1,3-butanedialkoxymethylsilyl)-1-propyl methanesulfonate; 6-(2-methyl-2,4-pentanedialkoxyethoxysilyl)-1-hexyl amine; 1-(2-methyl-2,4-pentanedialkoxyethoxysilyl)-5-hexyl acrylate; 8-(2-methyl-2,4-pentanedialkoxyethoxysilyl)-1-octyl methacrylate; 10-(2-methyl-2,4-pentanedialkoxyethoxysilyl)-1-decyl glycidyl ether; 3-(2-methyl-2,4-pentanedialkoxyethoxysilyl)-1-propyl trifluoromethanesulfonate; 3-(2-methyl-2,4-pentanedialkoxypropoxysilyl)-1-propyl amine; N-[3-(2-methyl-2,4-pentanedialkoxyisopropoxysilyl)-1-propyl]ethylene diamine; tris-N,N′,N″-[3-(2-methyl-2,4-pentanedialkoxybutoxysilyl)-1-propyl]diethylene triamine; tetrakis-N,N′,N″,N′″-[3-(2-methyl-2,4-pentanedialkoxyisopropoxysilyl)-1-propyl]triethylene tetramine; bis-(3-(2-methyl-2,4-pentanedialkoxyethoxysilyl)-1-propyl)sulfide; 6-(1,3-butanedialkoxyethoxysilyl)-1-hexyl amine; 1-(1,3-butanedialkoxyethoxysilyl)-5-hexyl glycidyl ether; 8-(1,3-butanedialkoxyethoxysilyl)-1-octyl acrylate; 10-(1,3-butanedialkoxyethoxysilyl)-1-decyl methacrylate; and bis-(3-(2-methyl-2,4-pentanedialkoxyethoxysilyl)-1-propyl)thioether.

In another embodiment, the cyclic dialkoxy organofunctional silanes are cyclic and bridging dialkoxy analogs to the 3-chloro-1-propyltriethoxysilane(3-triethoxysily-1-propyl chloride), used as a starting point for the manufacture of silane coupling agents as, for example, polysulfide silanes, such as triethoxysilylpropyl tetrasulfide referred to herein as TESPT, triethoxysilylpropyl disulfide referred to herein as TESPD. The cyclic and bridging dialkoxy haloalkyl silanes are novel and excellent alternatives to 3-triethoxysilyl-1-propyl chloride for use where reduced VOC emissions are desired.

The cyclic and bridging dialkoxy organofunctional silane compositions included herein may comprise single components or various mixtures of individual cyclic and bridging dialkoxy organofunctional silane components, organofunctional silane components, which contain only monofunctional alkoxy groups, and optionally including other species as well. Synthetic methods result in a distribution of various silanes, wherein mixtures of the starting components are employed for the purpose of generating mixtures of cyclic and bridging dialkoxy organofunctional silane products. Moreover, it is understood that the partial hydrolyzates and/or condensates of these cyclic and bridging dialkoxy organofunctional silanes, also referred to as cyclic and bridging dialkoxy organofunctional siloxanes and/or silanols, may be encompassed by the silanes herein as a side product of most methods of manufacture of the cyclic and bridging dialkoxy organofunctional silanes. Also, the partial hydrolyzates and/or condensates can occur upon storage of the cyclic and bridging dialkoxy organofunctional silanes, especially in humid conditions, or under conditions in which residual water remaining from their preparation is not completely removed subsequent to their preparation. Furthermore, partial to substantial hydrolysis of the cyclic and bridging dialkoxy organofunctional silanes may be deliberately prepared by incorporating the appropriate stoichiometry or excess of water into the methods of preparation described herein for the silanes. Also, the siloxane content of the cyclic and bridging dialkoxy organofunctional silanes may be deliberately prepared by incorporating the appropriate stoichiometry or excess of water into the methods of preparation for the silanes described herein. Silane structures herein encompassing hydrolyzates and siloxanes are described in the structures given in Formula 1 wherein the subscripts, v, of Z^{b}=(-O—)_{0.5} and/or u, of X═OH can be substantive, meaning substantially larger than zero.

The silane compounds with heterocyclic silicon groups included herein may be prepared by transesterification of organofunctional alkoxy-substituted silanes and diols with or without a catalyst, by the esterification of organofunctional silyl halides with diols, or by the hydrosilylation of substituted alkenes with a hydrosilane containing a heterocylic silicon group to generate cyclic and bridging silane compositions.

The transesterification of organofunctional alkoxy-substituted silanes and diols may be conducted with or without a catalyst. The catalyst may be an acid, a base or a transition metal catalyst. Suitable acid catalysts are hydrochloric acid, p-toluenesulfonic acid and the like. Typical base catalysts are sodium methoxide, sodium ethoxide. Suitable transition metal catalysts are tetraisopropyl titanate, dibutyltin dilaurate and dioctyltindilaurate.

During esterification of organofunctional silyl halides with diols, diols are added to the silyl halide with removal of the hydrogen halide formed. The hydrogen halide may be removed by sparging with nitrogen or by using reduced pressure. Any remaining halo groups can be removed by the addition of an alcohol such as methanol, ethanol, isopropanol, and the like.

In another embodiment, the diol-derived organofunctional silane can be prepared by reacting a catalyzed mixture of organofunctional silane reactant and diol with simultaneous distillation. The reaction leads to the alcohol exchange of one or more of the alkoxy groups selectively at the silicon atom of the organofunctioal silane reactant with the diol. The reaction is driven by the removal of the more volatile by-product alcohol by distillation. Suitable catalysts include acids such as p-toluenesulfonic acid, sulfuric acid, hydrochloric acid, chlorosilanes, chloroacetic acids, phosphoric acid, their mixtures, and so forth; bases such as sodium ethoxide; and, transition metal-containing catalysts such as titanium alkoxides, titanium-containing chelates, zirconium alkoxides, zirconium-containing chelates and mixtures thereof.

In yet another embodiment, the diol-derived organofunctional silane can be prepared by catalyzing a mixture of organofunctional silane and diol, in a first embodiment, at a molar ratio of at least about 0.5 moles of diol per alkoxy-silyl group to be transesterified, in a second embodiment, at a molar ratio of from about 0.5 to about 1.5 for a trialkoxy silane; and, in a third embodiment, from about 1.0 to about 1.5 for a trialkoxy silane. In each of the foregoing embodiments, the reaction temperature can range from about 10° C. to about 150° C. and in another embodiment from about 30° C. to 90° C. while maintaining a pressure in the range of from about 0.1 to about 2000 mm Hg absolute, and in another embodiment, from about 1 to about 80 mm Hg absolute. Excess diol can be utilized to increase reaction rate.

In another embodiment the diol-derived organofunctional silane can be prepared by slowly adding diol to organofunctional silane in the presence of catalyst at the desired reaction temperature and under vacuum. If desired, a neutralization step may be utilized to neutralize any acid or base catalyst that may have been utilized thereby improving product storage.

Optionally, an inert solvent may be used in the process. The solvent may serve as a diluent, carrier, stabilizer, refluxing aid or heating agent. Generally, any inert solvent, i.e., one which does not enter into the reaction or adversely affect the reaction, may be used. In one embodiment, solvents are those which are liquid under normal conditions and have a boiling point below about 150° C. Examples include aromatics, hydrocarbons, ethers, aprotic solvents and chlorinated hydrocarbon solvents such as, toluene, xylene, hexane, butane, diethyl ether, dimethylformamide, dimethyl sulfoxide, carbon tetrachloride, methylene chloride, and so forth.

In another embodiment, the diol-derived organofunctional silane can be prepared by continuously premixing the flow-streams of organofunctional silane reactant, diol, and catalyst (when employed) at appropriate ratios and then introducing the premixed reactants into a reactive distillation system, in one embodiment, a thin film distillation device operating at the desired reaction temperature and vacuum conditions. Conducting the reaction in a thin film under vacuum accelerates the removal of the alcohol by-product and improves the transesterification reaction rate. The vaporization and removal of the by-product alcohol from the film shifts the chemical equilibrium of the reaction to favor formation of the desired product and minimizes undesired side reactions.

The foregoing embodiment of the process herein comprises the steps of:

a) reacting, in a thin film reactor, a thin film reaction medium comprising organofunctional silane, e.g., a thiocarboxylate silane, diol and catalyst to provide diol-derived organofunctional silane and by-product alcohol;

b) vaporizing the by-product alcohol from the thin film to drive the reaction;

c) recovering the diol-derived organofunctional silane reaction product;

d) optionally, recovering the by-product alcohol by condensation; and,

e) optionally, neutralizing the diol-derived organofunctional silane product to improve its storage stability.

The molar ratio of diol to organofunctional silane reactant used in the foregoing continuous thin film process will depend upon the number of alkoxy groups that are desired to be replaced with diol. In one embodiment of the thin film process, a stoichiometric equivalent molar ratio of 1 is used wherein one diol replaces two alkoxy groups. Generally, for the practice of this embodiment, the molar ratio of diol to organofunctional silane can be varied within a range of from about 95 to about 125 percent of stoichiometric equivalence for each alkoxy-silyl group to be transesterified. In a particular embodiment, the molar ratio of diol to organofunctional silane can be within the range of from about 100 to about 110 percent of stoichiometric equivalence. In another embodiment, the molar ratio can be within a range of from about 100 to about 105 percent of stoichiometric equivalence for the molar ratio of diol to organofunctional silane. Those skilled in the art will recognize that excess diol could be utilized to increase reaction rates but such is ordinarily of no significant advantage when conducting the reaction in a thin film and only adds to the expense.

The apparatus and method of forming the film are not critical and can be any of those known in the art. Typical known devices include falling film or wiped film evaporators. Minimum film thickness and flow rates will depend on the minimum wetting rate for the film forming surface. Maximum film thickness and flow rates will depend on the flooding point for the film and apparatus. Vaporization of the alcohol from the film is effected by heating the film, by reducing pressure over the film or by a combination of both. It is preferred that mild heating and reduced pressure are utilized to form the diol-derived organofunctional silane of this invention. Optimal temperatures and pressures (vacuum) for running the thin film process will depend upon the specific starting organofunctional silane's alkoxy groups and diol used in the process. Additionally, if an optional inert solvent is used in the process, that choice will affect the optimal temperatures and pressures (vacuum) utilized.

Typical silane functionalities that are useful in the present invention include, but are not limited to, amino, epoxy, ureido, isocyanto, vinyl, sulfur, mercapto, carbamate, styrylamino, methacyloxy, alkyl, and polyether. Also useful are blocked phenolic silanes.

In accordance with another embodiment of the invention, blocked phenolic silane useful in the sizing composition has the general structural formula:
(R¹C(═O)O)_{y}C₆R^{II}_{6-y-z}[CₓH₂ₓSiXᵤZ^{b}ᵥZ^{c}_{w}]_{z}
where R^{I} is H, CH₃ or R^{V}O; R^{II} is H or R^{V}O; R^{V} is a linear or branched alkyl group from 1 to 4 carbon atoms; y is an integer from 1 to 3; z is an integer from 1 to 3; x is an integer from 2 to 6 and a is an integer from 0 to 2.

Additionally, the acyl or carbonate blocking group (R^{I}C(═O)—) needs to generate by-products (R^{I}C(═O)OH or CO₂ and R^{V}OH) that evaporate readily. Therefore the by-products should have a boiling point of less than 120° C. and preferably less than 100° C., at atmospheric conditions. This boiling point requirement can be achieve if the by-products form azeotropes with water. For example, 1-butanol is a potential by-product if the blocking group is butyl carbonate. It forms an azeotrope with water that boils at 93° C. The formyl blocking group is preferred because it deblocks more rapidly when the silane is added to water. The formyl group is more hydrophilic and therefore the solubility of the silane in water is increased. The formyl group also hydrolyzes faster in water. For example, the hydrolysis of 4-nitrophenyl formate is 440 times faster than the corresponding 4-nitrophenyl acetate. See E. R. Pohl, D. Wu, D. J. Hupe, Journal of the American Chemical Society, 102, 2759 (1980).

Examples of R^{I} are hydrogen, methyl, ethoxy, butoxy, isopropoxy or propoxy. Preferred R^{I} are hydrogen or methyl. Examples of R^{II} are hydrogen, methyl or methoxy. Preferred R^{II} are methoxy and hydrogen. The incorporation of R^{II} that are methoxy increase the solubility of the silane in water. The increase in water solubility shortens the time necessary to hydrolyze the alkoxysilyl ester and remove the blocking group. These R^{II} groups are not reactive with the resins during curing process nor do they increase the formation of undesirable color during the drying process and in-use.

Specific silanes include, but are not limited to, 4-acetoxy-1-(2-methyl-2,4 pentanedialkoxyethoxysilyl ethyl)benzene, 2-acetoxy-5-(2-methyl-2,4 pentanedialkoxyethoxysilyl propyl)anisole, 2-methoxy-5-(2-methyl-2,4 pentanedialkoxyethoxysilyl propyl)phenyl formate, 4-acetoxy-1-(2-methyl-2,4 pentanedialkoxyethoxysilyl propyl)benzene, methyl(2-methyl-2,4 pentanedialkoxyethoxysilyl propyl)phenyl carbonate, 2-acetoxy-4,6-bis-(2-methyl-2,4 pentanedialkoxyethoxysilyl propyl)anisole, 1-acetoxy-2,4,6-tris(2-methyl-2,4 pentanedialkoxyethoxysilyl propyl)benzene, 1,2-dimethoxy-6-acetoxy-4-(2-methyl-2,4 pentanedialkoxyethoxysilyl propyl)benzene, 4-[2-methyl-2,4 pentanedialkoxyethoxysilyl propyl]phenyl formate, and 4-[2-methyl-2,4 pentanedialkoxyethoxysilyl propyl]-2-methoxyphenyl formate, 4-acetoxy-1-(1,3-propanedialkoxyethoxysilyl ethyl)benzene, 2-acetoxy-5-(1,3-propanedialkoxyethoxysilyl propyl)anisole, 2-methoxy-5-(1,3-propanedialkoxyethoxysilyl propyl)phenyl formate, 4-acetoxy-1-(1,3-propanedialkoxyethoxysilyl propyl)benzene, methyl(1,3-propanedialkoxyethoxysilyl propyl)phenyl carbonate, 2-acetoxy-4,6-bis-(1,3-propanedialkoxyethoxysilyl propyl)anisole, 1-acetoxy-2,4,6-tris(1,3-propanedialkoxyethoxysilyl propyl)benzene, 1,2-dimethoxy-6-acetoxy-4-(1,3-propanedialkoxyethoxysilyl propyl)benzene, 4-[1,3-propanedialkoxyethoxysilyl propyl]phenyl formate, and 4-[1,3-propanedialkoxyethoxysilyl propyl]-2-methoxyphenyl formate, 4-acetoxy-1-(1,3-butanedialkoxyethoxysilyl ethyl)benzene, 2-acetoxy-5-(1,3-butanedialkoxyethoxysilyl propyl)anisole, 2-methoxy-5-(1,3-butanedialkoxyethoxysilyl propyl)phenyl formate, 4-acetoxy-1-(1,3-butanedialkoxyethoxysilyl propyl)benzene, methyl(1,3-butanedialkoxyethoxysilyl propyl)phenyl carbonate, 2-acetoxy-4,6-bis-(1,3-butanedialkoxyethoxysilyl propyl) anisole, 1-acetoxy-2,4,6-tris(1,3-butanedialkoxyethoxysilyl propyl)benzene, 1,2-dimethoxy-6-acetoxy-4-(1,3-butanedialkoxyethoxysilyl propyl)benzene, 4-[1,3-butanedialkoxyethoxysilyl propyl]phenyl formate, and 4-[1,3-butanedialkoxyethoxysilyl propyl]-2-methoxyphenyl formate, 4-acetoxy-1-(1,2-propanedialkoxyethoxysilyl ethyl)benzene, 2-acetoxy-5-(1,2-propanedialkoxyethoxysilyl propyl)anisole, 2-methoxy-5-(1,2-propanedialkoxyethoxysilyl propyl)phenyl formate, 4-acetoxy-1-(1,2-propanedialkoxyethoxysilyl propyl)benzene, methyl(1,2-propanedialkoxyethoxysilyl propyl)phenyl carbonate, 2-acetoxy-4,6-bis-(1,2-propanedialkoxyethoxysilyl propyl)anisole, 1-acetoxy-2,4,6-tris(1,2-propanedialkoxyethoxysilyl propyl)benzene, 1,2-dimethoxy-6-acetoxy-4-(1,2-propanedialkoxyethoxysilyl propyl)benzene, 4-[1,2-propanedialkoxyethoxysilyl propyl]phenyl formate, and 4-[1,2-propanedialkoxyethoxysilyl propyl]-2-methoxyphenyl formate.

The sizing composition (aqueous or nonaqueous) can also include film forming agent(s) which provide integrity to the fiber strand and compatibility of the sized fiber strand with the thermoplastic or thermosetting polymer reinforced by the fiber. Non-limiting examples of film forming agents include polyvinyl acetate homopolymers and copolymers and terpolymers, 1,2-epoxy polymers; 1,3-epoxy polymers; polyurethanes; epoxy polyurethane copolymers; polyacrylates including polymethacrylates; poly(ethylene)vinylacetate; butadiene; butadiene-styrene copolymers; polystyrene; acrylonitrile-butadiene-styrene; polyesters, both saturated and unsaturated; vinyl esters; polyamides; melamine-aldehyde condensates; phenolic aldehyde condensates; urea aldehyde condensates and the like. All of these polymeric materials are commercially available and are produced from known reactants.

The sizing composition can include cationic, anionic or non-ionic surfactants, anti-static agents, cross-linking agents, antioxidants, nucleating agents, pigments, etc.

Nonexclusive examples of lubricating materials that may be used in the sizing composition of the present invention include epoxy alkylated amines, alkyl trialkyl ammonium chloride, alkyl imidazoline derivatives, pelargonate, amides, tetraalkylene pentamine derivatives, acid-solubilized, fatty acid amides such as stearic amide, saturated and unsaturated fatty acid amides, wherein the acid group contains 4 to 24 carbon atoms; anhydrous, acid-solubilized polymers of the lower molecular weight unsaturated fatty acid amides; alkyl imidazoline derivatives such as alkyl-N-amido-alkyl imidazolines that may be formed by reacting fatty acids with polyalkylene polyamines under the conditions, which produce ring closure and the like. The amount of the lubricant used in the sizing composition is that amount which is conventionally used in aqueous sizing compositions, which is typically from about 0.1 to 5 weight percent of the sizing composition.

A dispersible, solubilizable or emulsifiable polyethylene polymer useful in the sizing composition of the present invention can be a low density or medium density polyethylene with a minimum degree of branching, high density polyethylene, which has comparatively straight and closely aligned molecular chains or ultra-high molecular weight polyethylene. It is believed, but the present invention is not limited by this belief, that the linearity of the polyethylene molecular chain assists in producing the slip/flow characteristic of the sized glass fiber strand of the present invention. The polyethylene polymer is preferably a polyethylene with limited branching and with a molecular weight of around 2,000 to around 250,000 or greater even up to around 1.5 million or more, where the high molecular weight is also solubilizable, dispersible of emulsifiable in aqueous solutions. By the terminology “with limited branching” it is meant that the polydispersity index (Mw/Mn) is less than 10 and preferably less than 3. The polyethylene with limited branching may also contain small amounts of methyl groups on the polymer backbone. The polyethylene with limited branching can be produced by the use of Ziegler-type catalysts and supported metal oxides. Examples of the processes for producing these polyethylene polymers include the Phillips Petroleum Company, the Ziegler-Natta Process and the Allied Corporation Process. Aqueous emulsions of the polyethylene with limited branching polymers are commercially available and these products have a milky emulsion appearance, a fairly high percentage of volatile water and are usually nonionic.

The amount of the dispersible or solubilizable or emulsifiable polyethylene polymer used in the sizing composition of the present invention ranges from about 0.1 to about 10 and, in another embodiment, about 0.1 to about 3 weight percent of the aqueous sizing composition. The amount of the polyethylene-containing polymer on a solids basis in the sizing composition is from about 1 to about 25 weight percent of the solids of the sizing composition.

In addition, the sizing composition of the present invention can include a soluble, emulsifiable or dispersible wax. The wax may be any suitable wax selected from the group consisting of vegetable waxes, such as camauba, Japan, bayberry, candelilla, and the like; animal waxes such as beeswax, Chinese wax, hydrogenated sperm oil wax and the like; mineral waxes such as ozocerite, montan, ceresin and the like; and synthetic waxes such as polyalkylenes like polyethylenes, polyethylene glycols, polyethylene esters, chloronaphthalenes, sorbitals, polychlorotrifluoroethylenes; petroleum waxes such as paraffin, microcrystalline waxes and the like. The waxes are preferably those having a high degree of crystallinity and obtained from a paraffinic source, and optionally are microcrystalline waxes. The microcrystalline waxes usually are branched chain paraffins having a crystal structure much smaller than that of normal wax and also a much higher viscosity, and they are obtained by dewaxing tank bottoms, refinery residues and other petroleum waste products. Of these waxes, the most preferred is that having a melting point of about 50° C. or more. The waxes are typically used in the sizing formulation of the instant invention as aqueous dispersions containing 20 to 60 percent by weight wax. In the aqueous sizing formulation of the present invention the wax component can be present in an amount of about 0 to about 6 and, in another embodiment, 0 to about 2 weight percent of the sizing composition. On a solids basis of the sizing composition, the dispersible wax can be present in an amount of about 0 to about 10 and, in another embodiment, about 0.1 to about 4 weight percent.

As can be appreciated by those skilled in the art, additional ingredients can be included in the aqueous sizing composition such as additional film formers, lubricants, wetting agents and silane coupling agents, surface energy modifiers such as surfactants for facilitating sizing stability, coatability, uniformity, and wettability, and process aids to promote mechanical handling properties during the fabrication and use of the resultant sized chopped glass fiber strand product.

The total solids (non-aqueous) content of the sizing composition can typically be about 1 to about 30 percent by weight of the size and preferably about 3 to about 18% by weight of the size. However, the amounts of the solids components of the aqueous sizing composition should not exceed that amount which will cause the viscosity of the solution to be greater than about 100 centipoise at 20° C. Solutions having a viscosity of greater than 100 centipoise at 20° C. are very difficult to apply to glass fiber strands during their formation without breaking the strand. The viscosity of the size should be between 1 and 20 centipoise at 20° C. for best results. The pH of the aqueous sizing composition can vary from about 3 to about 11.

The sizing composition is applied to the fibers to obtain a solids application of about 0.1 to about 3% by weight based on the total weight of the fibers and the sizing composition. The sizing composition is applied to the glass fibers during the conventional forming process to produce sized continuous glass fiber strands or wet chopped glass fiber strands. In producing wet chop or continuous glass fiber strands, the sizing composition is applied to the fibers prior to the time they are gathered together to form one or more strands by means of any applicator known in the art to contact a liquid with a solid object such as a roller applicator which is partially submerged in the sizing composition contained in a reservoir. The fibers can be gathered into one or more strands by one or more gathering shoes for winding onto a forming package rotating at a sufficient speed to attenuate the fibers from the orifices in the bushing of a glass fiber batch melting furnace. Also, the fibers can be gathered into one or more strands and passed to a pair of rotating wheel pullers that attenuates the fiber from the bushing. The wheel puller either disposes of the continuous strand into a suitable collecting device, or directs the strands to a chopping device for wet chopping. Other methods of applying the sizing composition to the strands of glass fibers such as pad applicators may be employed and a strand may be formed by means other than winding on the forming tube, or by means of a pair of rotating wheel pullers.

Also, as can be appreciated by those skilled in the art, any conventional method for producing wet chopped glass fiber strands or dry chopped glass fiber strands during the forming process for producing glass fibers can utilize the aqueous sizing composition of the present invention. The glass fiber strands that are formed by a wet chop or dry chop glass fiber forming process are dried in a drier for a time and at a temperature sufficient to remove a substantial amount of moisture from the strands and to set the cure of the coating. In the wet chop process, the drying is preferably performed at a short residence time and high temperature of around 150° C. or higher. In this case, it is preferred that the aqueous sizing composition used to treat the glass fiber strands contain the mixture of an amino silane and epoxy silane coupling agents in order to achieve good impact properties for the subsequently reinforced thermoplastic or thermosetting polymers. When the glass fiber strands are processed into continuous glass fiber strands, they are dried preferably in conventional drying ovens at temperatures of at least around 115° C. for around 11 hours or any other temperature/time condition relationship that will give equivalent drying. After this drying step, the continuous glass fiber strands can be chopped or processed into roving for reinforcement of thermoplastic or thermosetting polymers. The sized glass fiber strands in any form are now suitable for use in methods known to those skilled in the art for producing glass fiber reinforced thermoplastic and thermosetting polymers.

Non-aqueous sizing formulations using the silanes of the invention can be applied to the glass or carbon fibers by any method known to those skilled in the art such as during the formation of the glass fibers or after the glass fibers have cooled to a sufficient temperature to allow the application of the non-aqueous sizing composition. The non-aqueous sizing composition can be applied to glass fibers by applicators having belts, rollers, sprayers, and hot melt applicators.

While the above description contains many specifics, these specifics should not be construed as limitations of the invention, but merely as exemplifications of preferred embodiments thereof. Those skilled in the art will envision many other embodiments within the scope and spirit of the invention.

What is claimed is:

1. A sizing composition which comprises a liquid carrier containing silane which, upon hydrolysis, produces substantially no significant amount of volatile organic compound and/or the hydrolyzate of the silane.

2. The composition of claim 1 wherein the silane is a cyclic diol-substituted silane.

3. The composition of claim 1 wherein the silane has the general formula:
[Y[-G(-SiXᵤZ^{b}ᵥZ^{c}_{w})ₛ]ᵣ]ₙ (Formula 1)
wherein each occurrence of G is independently chosen from a set of groups comprising a polyvalent group derived by substitution of one or more hydrogen atoms of an alkyl, alkenyl, aryl or aralkyl group, or a molecular component which can be obtained by removal of one or more hydrogen atoms of a heterocarbon, with G containing from about 1 to about 30 carbon atoms; each occurrence of X is independently selected from the group consisting of —Cl, —Br, R¹O—, R¹C(═O)O—, R¹R²C═NO—, R¹R²NO— or R¹R²N—, —R¹, —(OSiR¹R²),(OSi R¹R²R³), and —O(R¹⁰CR¹¹)_{f}OH, wherein each occurrence of R¹⁰, R¹¹, R¹, R², and R³ is independently R; each occurrence of Z^{b} is independently (—O—)_{0.5}, and [—O(R¹⁰CR¹¹)_{f}O—]_{0.5}, wherein each occurrence of R¹⁰ and R¹¹ is independently R; each occurrence of Z^{c} is independently given by —O(R¹⁰CR¹¹)_{f}O— wherein each occurrence of R¹⁰ and R¹¹ is independently R; each occurrence of R is chosen independently from the set of groups comprising hydrogen; straight, cyclic or branched alkyl groups and may contain unsaturated, alkenyl groups, aryl groups, and aralkyl groups; or molecular components obtained by removal of one or more hydrogen atoms of a heterocarbon; each occurrence of R containing 1 to about 20 carbon atoms; each occurrence of the subscript f is independently an integer from 1 to about 15, each occurrence of n is an integer from 1 to about 100, with the proviso that when n is greater than 1, v is an integer greater than 0 and all the valences for Z^{b} have a silicon atom bonded to them, each occurrence of the subscript u is independently an integer from 0 to about 3, each occurrence of the subscript v is independently an integer from 0 to about 3, each occurrence of the subscript w is independently an integer from 0 to about 1, with the proviso that u+v+2w=3, each occurrence of the subscript r is independently an integer from 1 to about 6, each occurrence of the subscript t is independently an integer from 0 to about 50, and each occurrence of the subscript s is independently an integer from 1 to about 6; and each occurrence of Y is independently an organofunctional group of valence, r; and at least one cyclic and bridging dialkoxy organofunctional silane comprising the cyclic and bridging dialkoxy organofunctional silane composition containing at least one occurrence of Z^{b} or Z^{c}.

4. The composition of claim 3 wherein Y is selected from the group consisting of a univalent organofunctional group, a divalent organofunctional group, trivalent organo functional group, a tetravalent organo functional group and a polyvalent organofunctional group.

5. The composition of claim 4 wherein
the univalent organofunctional group is selected from the group consisting of CH₂═CH—, CHR═CH—, CR₂═CH—, mercapto, acryloxy, methacryloxy, acetoxy, —O—CH₂—C₂H₃O, —CH₂—CH₂—C₆H₉O, —C₆H₉O, —CR⁶(—O—)CR⁴R⁵, —OH, —NR⁴C(═O)OR⁵, —OC(═O)NR⁴R⁵, —NR⁴C(═O)SR⁵, —SC(═O)NR⁴R⁵, —NR⁴C(═S)OR⁵, —OC(═S)NR⁴R⁵, —NR⁴C(═S)SR⁵, —SC(═S)NR⁴R⁵, maleimide, maleate, substituted maleate, fumarate, substituted fumarate, —CN, citraconimide, —OCN, —N═C═O, —SCN, —N═C═S, —OR⁴, —F, —Cl, —Br; —I, —SR⁴, —S—SR⁴, —S—S—SR⁴, —S—S—S—S—SR⁴, —S—S—S—S—S—SR⁴, —SₓR⁴, —SC(═S)OR⁴, —SC(═S)SR⁴, —SC(═O)SR⁴, —NR⁴C(═O)NR⁵R⁶, —NR⁴C(═S)NR⁵R⁶, R⁴C(═O)NR⁵—, —C(═O)NR⁴R⁵—, R⁴C(═S)NR⁴—, melamine, cyanurato, —NH₂, —NHR⁴, —NR⁴R⁵, —NR⁴-L¹-NR⁵R⁶, —NR⁴-L¹(—NR⁵R⁶)₂, —NR⁴-L¹-N⁵-L²-NR⁶R⁷, —NR⁴-L¹(—NR⁵R⁶)₃, —NR⁴-L¹-NR⁵-L²-NR⁶-L³-NR⁷R⁸ and —NR⁴-L¹-N(-L²NR⁵R⁶)₂;
the divalent organofunctional group is selected from the group consisting of -(−)C(—O—)CR⁴R⁵, —CR⁵(—O—)CR⁴—, —O(R¹⁰CR¹¹)_{f}O—, -(−)NC(═O)OR⁵, —OC(═O)NR⁴—, -(−)NC(═O)SR⁵, —SC(═O)NR⁴—, -(−)NC(═S)OR⁵, —OC(═S)NR⁴—, -(−)NC(═S)SR⁵, —SC(═S)NR⁴—, —O—, maleate, substituted maleate, fumarate, substituted fumarate, —S—,—S—S—, —S—S—S—, —S—S—S—S—, —S—S—S—S—S—, —S—S—S—S—S—S—, —Sₓ—, —SC(═S)O—, —SC(═S)S—, —SC(═O)S—, -(−)NC(═O)NR⁴R⁵, —NR⁴C(═O)NR⁵—, -(−)NC(═S)NR⁴R⁵, —NR⁴C(═S)NR⁵—, R⁴C(═O)N(−)-, —C(═O)NR⁴—, R⁴C(═S)N(−)-, divalent melamine, divalent cyanurato, —NH—, —NR⁴—, -(−)N-L¹-NR⁴R⁵, —NR⁴-L¹-NR⁵—, -(−)NR⁴)₂-L¹-NR⁵R⁶, -(−)N-L¹-NR⁵-L²-NR⁶R⁷, —NR⁴-L¹-N(−)-L²-NR⁵R⁶, —NR⁴-L¹NR⁵-L²-NR⁶—, -(−)N-L¹-(NR⁵R⁶)₃, (—NR⁴)₂-L¹-(NR⁵R⁶)₂, -(−)N-L¹-NR⁴-L²-NR⁵-L³-NR⁶R⁷, —NR⁴-L¹-N(−)-L²-NR ⁶R⁷, —-NR⁴-L¹-NR⁵-L²-N(−)-L³-NR⁶R⁷, −NR⁴-L¹-NR⁵-L²-NR⁶-L³-NR⁷, -(−)N-L¹-N(-L²NR⁵R⁶)₂, and (—NR⁴L¹-)₂N-L²NR⁵R⁶;
the trivalent organofunctional group is selected from the group consisting of
-(−)C(—O—)CR⁴—, -(−)NC(═O)O—, -(−)NC(═O)S—, -(−)NC(═S)O—, -(−)NC(═S)S—, -(−)NC(═O)NR⁴—, -(−)NC(═S)NR⁴—, —C(═O)N(−)-, —C(═S)N(−)-, trivalent melamino; trivalent cyanurato, —N(−)-, -(−)N-L¹-NR⁴—, (—NR⁴)₃-L¹, (—NR⁴)₂-L¹-NR⁵-, -(−)N-L¹-N(−)-L²-NR³R⁴, —NR⁴-L¹-N(−)-L²-NR⁵−, -(−)N-L¹-NR⁴-L²-NR⁵—, -(−N-L¹-N(−)-L²-NR⁵-L³-NR³R⁴, —NR⁴-L¹-N(−)-L²-N(−)-L³-NR³R⁴, -(−)N-L¹-NR⁵-L²-N(−)-L³NR³R⁴, —NR⁴-L¹-N(−)-L²-NR³-L³-NR⁴—, -(−)N-L¹-N(-L²NR³R⁴)(-L²NR⁵—), (—NR⁴L¹—)₃N, -(−)C(—O—)C(−)-, -(−)NC(═O)N(−), -(−)NC(═S)N(−)-, tetravalent melamino, -(−)N-L¹-N(−)-, (—NR⁴)₄-L¹, (—NR⁴)₂-L¹-N(−)-, -(−)N-L¹-N(−)-L²-NR³—, -(−)N-L¹-NR⁴-L²(−)-, -(−)N-L¹-N(−)-L²-N(−)-L³-NR⁴R³, —NR⁴-L¹-N(−)-L²-N(−)-L³-NR³—, -(−)N-L¹-NR⁴-L²-NR³-L³-N(−)- and -(−)N-L¹-N(-L²NR³—)₂;
the polyvalent organofunctional group is selected from the group consisting of
polyvalent hydrocarbon groups, (—NR³)(—N—)₂C₃N₃, (—N—)₃C₃N₃, -(−)N-L¹-N(−)-L²-N(−)-, -(−)N-L¹-N(−)-L²-N(−)-L³-NR³—, -(−)N-L¹-NR³-L²-N(−)-L³-N(−)-, [-(−)N-L¹-]₂N-L²NR³—, -(−)N-L¹-N(−)-L²-N(−)-L³-N(−)- and [-(−)N-L¹-]₃; and
wherein each occurrence of L¹, L², and L³ is selected independently from the set of structures given above for G, x is independently an integer from 1 to 10 and each occurrence of R is independently given by one of the structures listed above for R and R¹⁻¹¹.

6. The composition of claim 5 wherein the dialkoxy or difunctional alkoxy is represented by the formula:
—O(R¹⁰CR¹¹)_{f}O— (Formula 3)

7. The composition of claim 3 wherein G is selected from the group consisting of a monovalent hydrocarbon group,
CH₃(CH₂)ₚ— wherein p is 1 to 20,
diethylene cyclohexane,
1,2,4-triethylene cyclohexane,
diethylene benzene,
phenylene, —CH₂)ₘ— wherein m is 1 to 12 and
CH₂(CH₂)_{q}CH(CH₃)— wherein q is zero to 17.

8. The composition of claim 3 wherein R and R¹⁻¹¹ is independently selected from the group consisting of methyl, ethyl, propyl, isopropyl, octenyl, cyclohexyl, butyl, phenyl, benzyl, tolyl, allyl, methoxyethyl, ethoxyethyl, dimethylaminoethyl and cyanoethyl.

9. The composition of claim 3 wherein R¹⁰ and R¹¹ is each independently selected from a group consisting of hydrogen, methyl, and ethyl.

10. The composition of claim 3 wherein R¹ and R² is each independently selected from the group consisting of hydrogen, methyl, ethyl and propyl.

11. The composition of claim 3 wherein R³, R⁴, R⁵, R⁶, R⁷ and R⁸ are independently selected from the group consisting of phenyl, methyl, butyl, H and ethyl.

12. The composition of claim 3 wherein X is selected from the group consisting of methoxy, ethoxy, isobutoxy, propoxy, isopropoxy, acetoxy, methoxyethoxy, oximato and monovalent alkoxy groups derived from diols.

13. The composition of claim 3 wherein Z^{b} and Z^{c} are selected from the group consisting of divalent alkoxy groups derived from the diols consisting of ethylene glycol, propylene glycol, neopentyl glycol, 1,3-propanediol, 2-methyl-1,3-propanediol, 1,3-butanediol, and 2-methyl-2,4-pentanediol.

14. The composition of claim 3 wherein a ratio of w/v is between 1 and 9;
X is R¹O—, R¹C(═O)O—;
Z^{b} and Z^{c} are derived from the group of diols consisting of 1,3-propanediol, 2-methyl-1,3-propanediol, 1,3-butanediol, 2-methyl-2,4-pentanediol;
R¹ is independently selected from the group consisting of alkyls of C₁ to C₄ and H; and
G is a divalent straight chain alkyl of 2 to 18 carbon atoms.

15. The composition of claim 3 wherein the ratio of w/v is between about 2 and about 8,
X is ethoxy or one or more of the divalent alkoxy groups derived from the diols selected from the group consisting of 1,3-propanediol, 2-methyl-1,3-propanediol, 1,3-butanediol, and 2-methyl-2,4-pentanediol, and
G is a C₂-C₂C₁₂ straight-chain alkyl derivative.

16. The composition of claim 1 wherein the silane is a blocked phenolic silane.

17. The composition of claim 1 wherein the liquid carrier includes water and/or an organic compound.

18. The composition of claim 1 further comprising one or more of a film forming agent, surfactant, lubricant, and/or wax.

19. A fiber sized with the composition of claim 1.

20. The fiber of claim 19 wherein the fiber is a glass fiber.
